(19) United States
(12) Patent Application Publication
(10) Pub. No.: US 2005/0013358 A1
(43) Pub. Date: Jan. 20, 2005

(54) Method and apparatus for video noise reduction

(75) Inventors: Byung-cheol Song, Suwon-si (KR); Kang-wook Chun, Hwaseong-gun (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/884,921

(22) Filed: Jul. 7, 2004

(30) Foreign Application Priority Data
Jul. 16, 2003 (KR) 2003-48650

(51) Int. Cl. H04N 7/12

(52) U.S. Cl. 375/240.2; 375/240.18

(57) ABSTRACT

A method and apparatus remove noise from video or still image signals by rebuilding video or still image signals received via a communication channel in blocks and converting the blocks into data in the frequency domain. The noise reduction method includes: classifying a received original signal into predetermined size blocks; decomposing a received signal into a predetermined number of equal sized blocks; generating at least one rebuilt signal by removing first predetermined numbers of pixels from the beginning of the decomposed signal and second predetermined numbers of pixels from the end of the decomposed signal; and removing noise in the frequency domain by converting the original signal and the rebuilt signals into signals in the frequency domain. As a result, noise in still image and video signals is effectively removed.

### BACKGROUND OF THE INVENTION

This application is based on and claims the priority from Korean Patent Application No. 2003-48650, filed on Jul. 16, 2003, in the Korean Intellectual Property Office, the disclosure of which is incorporated herein in its entirety by reference.

1. Field of the Invention

The present invention relates to video noise reduction, and more particularly, to a method and apparatus for removing noise from a video or still image signal by rebuilding still images or moving images received via a communication channel in blocks and converting the blocks into data in the frequency domain.

2. Description of the Related Art

In general, since there is noise in a communication channel through which still images or moving images are transferred, the images received at a receiving end are distorted when displayed. When the images distorted by the noise are displayed on a display device, they are unpleasant to the eye and compression efficiency is decreased when the images are stored by being compressed according to moving image compression standards, such as Moving Picture Expert Group (MPEG) standards.

Therefore, research into removing noise from moving images or still images is actively being performed. A conventional noise reduction method includes a spatial noise reduction method and a temporal noise reduction method.

FIG. 1 is a block diagram of a conventional video encoder.

In order to perform a video on demand (VOD) service or moving image communication, the encoder generates a bit stream encoded using a predetermined compression method.

A discrete cosine transform (DCT) unit 110 discrete cosine transforms video data input in 8×8 pixel blocks in order to remove a spatial redundancy. A quantization unit 120 quantizes DCT coefficients obtained by the DCT unit 110 and performs high data loss compression by expressing the result using several representative values. An inverse quantization unit 130 dequantizes the video data quantized by the quantization unit 120. An inverse discrete cosine transform (IDCT) unit 140 inverse discrete cosine transforms the video data dequantized by the inverse quantization unit 130. A frame memory unit 150 stores the video data received from the IDCT unit 140 in frame units. A motion estimation and compensation (ME/MC) unit 160 calculates a sum of absolute difference (SAD) corresponding to a moving vector (MV) for macro block and a block matching error using video data of a present frame and video data of a previous frame stored in the frame memory unit 150. A variable length coding (VLC) unit 170 removes statistical redundancy from the quantized discrete cosine transformed video data according to the MV calculated by the ME/MC unit 160.

FIG. 2 is a block diagram of a video encoder using a conventional noise reduction method.

Referring to FIG. 2, a pre-processor 210 is added to the conventional video encoder 220 of FIG. 1. The pre-processor 210 removes noise from input video data using the conventional noise reduction method and inputs the video data with reduced noise to the video encoder 220

A noise reduction method used in the pre-processor 210 includes a spatial noise reduction method, a temporal noise reduction method, and a spatial-temporal noise reduction method.

With reference to FIGS. 1 and 2, most conventional noise reduction apparatuses remove noise before encoding by placing a pre-processor before a video encoder, or after decoding by placing a post-processor after a video decoder. A noise reduction method performed by the pre-processor or the post-processor includes a method of removing noise by spatial filtering using a spatial division and a method of removing noise by selective low-pass filtering on a time axis. However, blurring of the video often results from the noise reduction method using the spatial division, and an afterimage phenomenon occurs in the noise reduction method using the temporal division.

### SUMMARY OF THE INVENTION

The present invention provides a method and apparatus for effectively removing noise in the frequency domain by converting still or video data distorted by the noise into data in the frequency domain.

According to an exemplary embodiment of the present invention, there is provided a noise reduction method including: (a) classifying a received original signal into a predetermined number of equal size blocks; (b) generating at least one block rebuilt signal by removing predetermined numbers of pixels from the beginning of the decomposed signal; and (c) removing noise in the frequency domain by converting the original signal and the rebuilt signal into signals of the frequency domain.

The original signal may be a video signal or a still image signal.

The block-rebuilt signal may be generated by sequentially removing the predetermined numbers of pixels from the beginning of the decomposed signal until removing the predetermined number of pixels would completely remove a first block of the decomposed signal.

The block-rebuilt signal may be generated by removing a half of the number of pixels of the block from the very front portion of the classified signal.

The noise reduction in the frequency domain may include: (c1) performing predetermined frequency conversion of the original signal and the rebuilt signal, respectively; (c2) removing noise on the frequency-converted signal; (c3) performing frequency inverse conversion of the noise-removed signal; and (c4) averaging and outputting the inverse frequency converted signal.

According to another exemplary embodiment of the present invention, there is provided a noise reduction apparatus including: a data separator, which classifies a received original signal into predetermined size blocks and generates a block-rebuilt signal by removing a predetermined number of pixels from the beginning of the decomposed signal; a frequency converter, which performs frequency conversion of the rebuilt signal; a noise reducer, which removes noise on the frequency-converted signal; a frequency inverse converter, which performs frequency inverse conversion of the noise-removed signal; and an average calculator, which calculates an average of the inverse frequency converted signal.

The noise reducer may further include a noise level estimator, which estimates a noise level of the received original signal and transfers the estimated information to the noise reducer.

The data separator may generate the block rebuilt signal by sequentially removing the predetermined numbers of pixels from the beginning of the decomposed signal until removing the predetermined number of pixels would completely remove a first block of the decomposed signal.

The data separator may generate the block rebuilt signal by removing a half of the number of pixels of the block from the very front portion of the classified signal.

The frequency conversion may be a unitary transform.

According to another exemplary embodiment of the present invention, there is provided a computer readable medium with a computer readable program for performing the above-mentioned noise reduction method recorded thereon.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional video encoder;

FIG. 2 is a block diagram of a video encoder using a conventional noise reduction method;

FIG. 3 is a block diagram of a noise reduction apparatus according to an exemplary embodiment of the present invention;

FIG. 4 is a timing diagram for describing how to decompose a noise-mixed signal into blocks and generate L−1 rebuilt signals;

FIG. 5 is a flowchart illustrating a video noise reduction method according to an exemplary embodiment of the present invention.

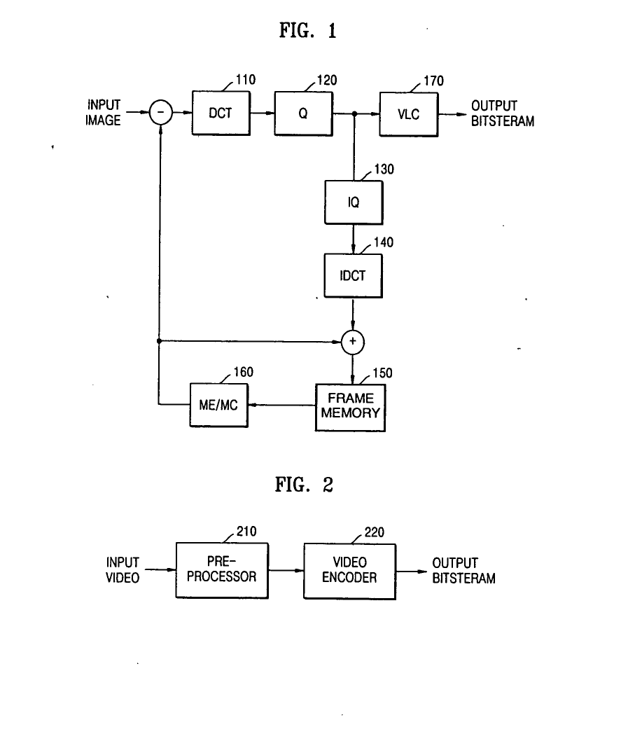

### DETAILED DESCRIPTION OF THE INVENTION

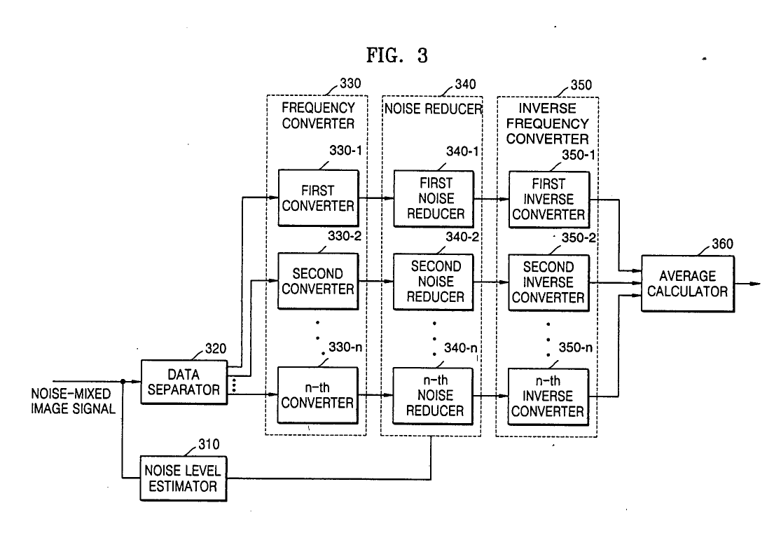

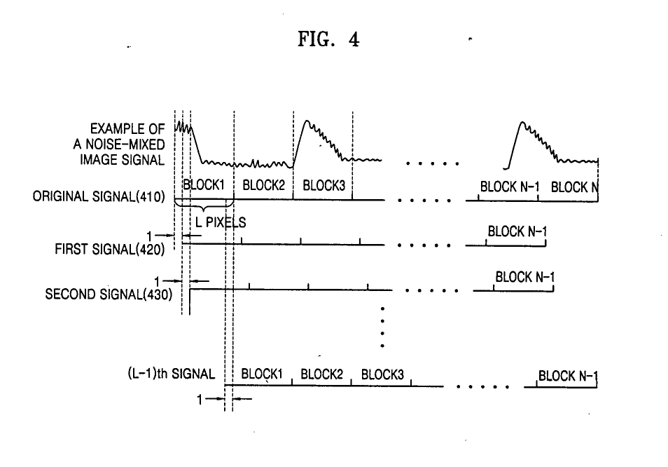

FIG. 3 is a block diagram of a noise reduction apparatus according to an exemplary embodiment of the present invention.

The noise reduction apparatus includes a noise level estimator 310, a data separator 320, a frequency converter 330, a noise reducer 340, an inverse frequency converter 350, and an average calculator 360. The frequency converter 330 includes first through n-th converters 330-1 through 330-n where n is equal to the number of blocks of an input signal. The noise reducer 340 includes first through n-th reducers 340-1 through 340-n and the inverse frequency converter 350 includes first through n-th inverse converters 350-1 through 350-n.

The noise level estimator 310 estimates a noise level of the input signal. The noise level estimator 310 is not required for the noise reduction apparatus according to the present invention but is beneficial for improving noise reduction efficiency.

The data separator 320 decomposes an input noise-mixed image signal (original signal) into N blocks, each block having L pixels, and generates L−1 signals by building N−1 blocks, each block having L pixels, by sequentially shifting one pixel along the decomposed signal. The generation of the L−1 signals will be described in detail with reference to FIG. 4. The decomposed original and L−1 signals are transmitted to the frequency converter 330.

The frequency converter 330 converts the signals received from the data separator 320 into signals of the frequency domain by performing a unitary transform on the generated signals. The unitary transform is preferably a DCT but may also be a discrete sine transform (DST), a discrete Walsh transform (DWT), a discrete Hadamard transform (DHT), a Haar transform, a Slant transform, or a Karhunen-Loeve (KL) transform.

The noise reducer 340 removes noise from the frequency converted signals using a frequency conversion matrix in the frequency domain, such as inner product calculations of DCT coefficient matrices and sends the reduced noise signals to the frequency inverse converter 350.

A filter coefficient used to remove noise is calculated by taking inner products of filter coefficient matrices in the frequency domain and is determined according to the estimated noise level received from the noise level estimator 310. For example, if Wiener filtering based on the DCT is used for noise reduction, a Wiener filter coefficient is determined according to the noise level input from the noise level estimator 310. However, when the unitary transform, such as the DCT, is used to remove noise, the Wiener filtering can be performed by calculating a simple inner product of matrices in the frequency domain. Therefore, frequency conversion according to the exemplary embodiment of the present invention is a unitary transform, such as the DCT.

The inverse frequency converter 350 converts the noise-reduced signals from signals in the frequency domain and transmits each of the inverse frequency converted signals to the average calculator 360. Then, the average calculator 360 averages and outputs the inverse frequency converted signals.

FIG. 4 is a timing diagram for describing how to decompose a noise-mixed signal into blocks and generate L−1 rebuilt signals.

With reference to FIGS. 3 and 4, if one-dimensional processing is applied to rows in the vertical direction and rows in the horizontal direction, respectively, two-dimensional video data is obtained. Therefore, for convenience of description, one-dimensional signals will now be described.

In the noise reduction method according to a second exemplary embodiment of the present invention, one-dimensional signals are rebuilt as in FIG. 4 before signals are converted into the frequency domain. After noise is removed from signals converted into the frequency domain, the result is averaged and output.

With reference to FIG. 4, generation of L−1 rebuilt signals will be described.

An original signal 410 composed of M pixels is decomposed into N (=M/L) blocks, each block having L pixels. Then, one pixel is removed from the beginning of the decomposed original signal 410, N−1 blocks, each having L pixels following the removed pixel are formed, and a first signal 420 is built. The first signal 420 does not include the first one pixel and the last L−1 pixels of the decomposed original signal 410. Then, two pixels are removed from the beginning of the decomposed original signal 410, N−1 blocks, each having L pixels following the removed pixels are formed, and a second signal 430 is built. The second signal 430 does not include the first two pixels and the last L−2 pixels of the decomposed original signal. Likewise, L−1 signals are built, each signal shifting one pixel along the decomposed original signal 410.

Noise in the signals is reduced by filtering the decomposed original signal and the L−1 signals after the decomposed original signal and the L−1 signals are converted into the frequency domain. Noise can be removed by performing frequency conversion on all L−1 signals. However, in consideration of the amount of computation, noise also can be removed by performing frequency conversion on only a portion of the signals. For example, by using only two signals, that is, the original signal decomposed into blocks and a signal with blocks built after removing the first L/2 pixels, frequency conversion, noise reduction, inverse frequency conversion, and average calculation are performed.

For two-dimensional video data, two-dimensional noise reduction is performed by independently performing the above-described one-dimensional method in a vertical direction and a horizontal direction. Also, an input signal can be classified into a two-dimensional domain and the frequency conversion can also be performed as a two-dimensional conversion. In this case, the data separator 320 divides an input video into images, each with a maximum size of L×L pixels, noise of the images is removed, and inverse frequency converted signals are averaged. Since the amount of computation is large for two-dimensional signal calculations, the computation is performed for only a portion of the signals.

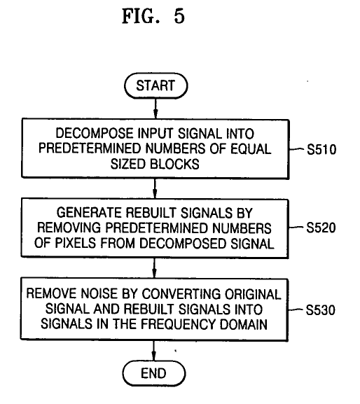

FIG. 5 is a flowchart illustrating a video noise reduction method according to an exemplary embodiment of the present invention.

An original signal, for example, a still image signal or a video signal, is decomposed into a predetermined number of equal-sized blocks in step S510.

At least one rebuilt signal is generated in step S520 by removing a predetermined number of pixels from the beginning of the first block of the decomposed original signal. If the number of pixels in each of the blocks is L, up to L−1 rebuilt signals can be generated by shifting along the decomposed original signal one pixel at a time, each rebuilt signal having N−1 blocks with L pixels each. If only one rebuilt signal is generated, the first and last L/2 pixels are removed.

In step S530, noise is removed in the frequency domain by converting the decomposed original signal and the rebuilt signals into signals in the frequency domain. In particular, the noise reduction in the frequency domain includes performing predetermined frequency conversions of the decomposed original signal and the rebuilt signals, removing noise from the frequency-converted signals, performing inverse frequency conversion on the noise-removed signals, and averaging and outputting the inverse frequency converted signal.

The present invention may be embodied in a general-purpose computer by running a program from a computer readable medium, including but not limited to storage media such as magnetic storage media (e.g., ROMs, RAMs, floppy disks, magnetic tapes, etc.), optically readable media (e.g., CD-ROMs, DVDs, etc.), and carrier waves (e.g., transmission over the Internet). The present invention may also be embodied as a computer readable medium having a computer readable program code unit embodied therein for causing a number of computer systems connected via a network to effect distributed processing.

As described above, a noise reduction method and apparatus according to exemplary embodiments of the present invention can effectively remove noise from still or video images by decomposing an input signal into blocks, removing a predetermined number of pixels from the decomposed block to generate rebuilt signals, and converting the rebuilt signals into signals in the frequency domain.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A noise reduction method comprising:
(a) generating a decomposed signal by decomposing an input signal into a predetermined number of blocks each having a same number of pixels;
(b) generating at least one rebuilt signal by removing a predetermined number of pixels from a beginning of the decomposed signal; and
(c) removing noise in the frequency domain by converting the decomposed signal and the rebuilt signal into signals in the frequency domain.

2. The method of claim 1, wherein the input signal is a video signal or a still image signal.

3. The method of claim 1, wherein step (b) comprises:
generating L−1 rebuilt signals each having N−1 blocks, wherein L is the number of pixels in each block of the rebuilt signals, N is the number of blocks of the decomposed signal, and each rebuilt signal l, where l=1 to L−1, is generated by removing the first l pixels from the beginning of the decomposed signal.

4. The method of claim 1, wherein step (b) comprises:
generating one rebuilt signal by removing a first L/2 of the pixels of the first block of the decomposed signal and a last L/2 of the pixels of a last block of the decomposed signal, where L equals the number of pixels in each block of the decomposed signal.

5. The method of claim 1, wherein step (c) comprises:
(c1) frequency converting the decomposed signal and the at least one rebuilt signal, respectively to generate frequency-converted signals;
(c2) removing the noise from the frequency-converted signals to generate reduced-noise signals;
(c3) performing inverse frequency conversion on the reduced-noise signals to generate inverse frequency converted signals; and
(c4) averaging the inverse frequency converted signals.

6. The method of claim 5, wherein step (c1) comprises subjecting the decomposed signal and the at least one rebuilt signal to a unitary transform.

7. The method of claim 5, wherein step (c2) comprises reducing the noise by calculating an inner product of conversion coefficient matrices of the frequency-converted signals.

8. The method of claim 5, wherein step (c2) comprises reducing the noise using a Wiener filtering method based on a discrete cosine transform (DCT).

9. A noise reduction apparatus comprising:
a data separator, which generates a decomposed signal by decomposing an input signal into a predetermined number of blocks, each having a same number of pixels, and generates at least one rebuilt signal by removing a predetermined number of pixels from a beginning of the decomposed signal;
a frequency converter, which performs frequency conversion on the at least one rebuilt signal and the decomposed signal to generate frequency converted signals;
a noise reducer, which removes noise from the frequency-converted signals to generate noise-reduced signals;
an inverse frequency converter, which performs inverse frequency conversion of the noise-reduced signals to generate inverse frequency converted signals; and
an average calculator, which calculates an average of the inverse frequency converted signals.

10. The apparatus of claim 9, further comprising:
a noise level estimator, which estimates a noise level of the input signal and outputs estimation information to the noise reducer.

11. The apparatus of claim 9, wherein the data separator generates L−1 rebuilt signals each having N−1 blocks, wherein L is the number of pixels in each block of the decomposed signal and the rebuilt signals, N is the number of blocks of the decomposed signal, and each rebuilt signal l, where l=1 to L−1, is generated by removing the first l pixels from a first block of the decomposed signal and the last (L−l) pixels from a last block of the decomposed signal.

12. The apparatus of claim 9, wherein the data separator generates the at least one rebuilt signal by removing a first L/2 of the pixels of a first block of the decomposed signal and a last L/2 of the pixels of a last block of the decomposed signal, where L equals the number of pixels in each block of the decomposed signal.

13. The apparatus of claim 9, wherein the frequency conversion comprises a unitary transform.

14. The apparatus of claim 9, wherein the noise reducer removes the noise by calculating an inner product calculation of coefficient matrices of the frequency-converted signals.

15. A computer readable medium with a computer readable program for performing a noise reduction method recorded thereon, the method comprising:
(a) generating a decomposed signal by decomposing an input signal into a predetermined number of equal sized blocks;
(b) generating at least one rebuilt signal by removing a predetermined number of pixels from a beginning of the decomposed signal; and
(c) removing noise in the frequency domain by converting the decomposed signal and the rebuilt signals into signals in the frequency domain.
